(19) United States
(12) Patent Application Publication
(10) Pub. No.: US 2023/0122060 A1
(43) Pub. Date: Apr. 20, 2023

(54) CABLE CONNECTORS AND CABLE CONNECTOR SYSTEMS AND METHODS INCLUDING SAME

(71) Applicants: TE Connectivity Solutions GmbH, Schaffhausen (CH); Tyco Electronics Canada ULC, Markham (CA); Tyco Electronics-Simel, Gevrey-Chambertin (FR)

(72) Inventors: Barry James Johnson, Vaughan (CA); Alexandru P. Bulza, Newmarket (CA); Sachidanandan Murugiah, Stouffville (CA); Jonathan Guppy, Ajax (CA); Sarzil Rahman, Scarborough (CA); Mahmoud Seraj, Benson, NC (US); Benoit Millot, Aiserey (FR); Brian Ayres, Raleigh, NC (US); Sean Kennedy, Raleigh, NC (US)

(21) Appl. No.: 18/045,568

(22) Filed: Oct. 11, 2022

(30) Foreign Application Priority Data
Oct. 14, 2021 (EP) 21306441.3

(51) Int. Cl. H01R 13/207; H01R 13/621; H01R 4/30

(52) U.S. Cl. CPC H01R 13/207; H01R 13/6215; H01R 4/30

(57) ABSTRACT

A cable connector (100-900) for connecting an electrical cable, the electrical cable including a cable conductor having a terminal end portion, the terminal end portion having an end face, includes an electrically conductive connector body (110), a conductor bore (102) in the connector body (110), a securing mechanism, and a contact mechanism (141). The connector bore (102) defines a conductor bore axis and is configured to receive the terminal end portion of the cable conductor along the conductor bore axis. The securing mechanism is operable to clamp onto the terminal end portion. The contact mechanism (141) includes a pressure member (170A, 170B), an electrical contact surface, and a drive mechanism (151). The drive mechanism (151) is selectively operable to drive the pressure member (170A, 170B) to force the electrical contact surface against the end face of the cable conductor.

### RELATED APPLICATION(S)

The present application claims priority to European Patent Application No. 21306441.3, filed Oct. 14, 2021, the entire content of which is incorporated herein by reference.

### FIELD

The present invention relates to connectors and methods for forming electrical connections.

### BACKGROUND

Electrical connectors are used to connect electrical cables, such electrical power transmission cables in an electrical power distribution network. In the electrical utilities industry, maintaining cable integrity is critical. A loss of cable integrity, for example, a short circuit in a high voltage cable, may result in a crippling power outage or, even worse, a loss of life. One everyday task that may pose a great threat to cable integrity is the formation of electrical connections.

In some applications, cable ends are secured to a cable using fastening bolts. In some applications, it is desirable or necessary to install a fastener, such as a bolt, with a prescribed torque, thereby ensuring that the bolt is installed to a tightness in a desired range. Although a torque-controlled driver (e.g., a torque wrench) may be employed for this purpose, a torque-controlled driver may be unavailable or inconvenient. Torque-controlled fasteners such as shear bolts have been designed to provide torque control integral with the fastener. Examples of shear bolt fasteners include one-piece shear bolts provided with electrical connectors available from TE Connectivity. Some of these shear bolts include a one-piece bolt member having a head, a threaded shaft, and one or more shear sections defined in the shaft. During installation, a driver is used to apply torque to the head until the shaft shears at one of the shear sections, whereupon the head breaks off and a remaining portion of the fastener remains to fasten the cable.

When electrical connections are formed, a bare metal surface may be exposed such as a splice connector. If the connection is made between two insulated cables, it may be necessary or desirable to effectively rebuild the cable's electrical insulation, metallic shield, and environmental protection over this connection. If the connection was energized without rebuilding the cable layers, the metallic connection may fail immediately or very soon after.

### SUMMARY

According to a first aspect, a cable connector for connecting an electrical cable, the electrical cable including a cable conductor having a terminal end portion, the terminal end portion having an end face, includes an electrically conductive connector body, a conductor bore in the connector body, a securing mechanism, and a contact mechanism. The connector bore defines a conductor bore axis and is configured to receive the terminal end portion of the cable conductor along the conductor bore axis. The securing mechanism is operable to clamp onto the terminal end portion. The contact mechanism includes a pressure member, an electrical contact surface, and a drive mechanism. The drive mechanism is selectively operable to drive the pressure member to force the electrical contact surface against the end face of the cable conductor.

According to one embodiment, the electrical contact surface can form a part of the pressure member.

According to one embodiment, the pressure member can include raised features forming the electrical contact surface.

According to one embodiment, the cable connector can include a second conductor bore in the connector body, the second connector bore being configured to receive a second terminal end portion of a second cable conductor; and a second securing mechanism operable to clamp onto the second terminal end portion; the contact mechanism can include: a second pressure member; and a second electrical contact surface; and the drive mechanism is selectively operable to drive the second pressure member to force the second electrical contact surface against a second end face of the second cable conductor to form an electrical splice connection between the first and second cable conductors.

According to one embodiment, the electrical contact surface can be configured to engage both inner conductor strands of the cable conductor and outer conductor strands of the cable conductor to establish electrical continuity between the inner conductor strands and the connector body through the outer conductor strands.

According to one embodiment, the electrical contact surface can be configured to engage inner conductor strands of the cable conductor to establish electrical continuity between inner conductor strands and the connector body through the electrical contact surface.

According to one embodiment, the drive mechanism can include: a wedge member; and a drive bolt operable to drive the wedge member to drive the pressure member to force the electrical contact surface against the end face of the cable conductor.

According to one embodiment, the wedge member can include a first interlock feature; the pressure member can include a second interlock feature; and the first and second interlock features are engaged with one another to slidably couple the pressure member to the wedge member.

According to one embodiment, the drive bolt of the drive mechanism can be a shear bolt.

According to one embodiment, the drive mechanism can include a spring operative to maintain a tension on the drive bolt.

According to one embodiment, the spring of the drive mechanism can be a Belleville washer.

According to one embodiment, the cable connector can include: a second conductor bore in the connector body, the second connector bore being configured to receive a second terminal end portion of a second cable conductor; and a second securing mechanism operable to clamp onto the second terminal end portion; the contact mechanism can include: a second pressure member; and a second electrical contact surface; and the drive bolt is selectively operable to drive both: the first pressure member to force the first electrical contact surface against the first end face of the first cable conductor, and the second pressure member to force the second electrical contact surface against a second end face of the second cable conductor, to form an electrical splice connection between the first and second cable conductors.

According to one embodiment, the drive bolt can be a shear bolt; the cable connector can include an elongate slot defined in the connector body; the drive bolt can be slidably mounted in the elongate slot to permit the drive bolt to slide along the conductor bore axis; the first electrical contact surface can form a part of the first pressure member; the second electrical contact surface can form a part of the second pressure member; and the first and second securing mechanisms can be shear bolts.

According to one embodiment, the drive mechanism can include a tapered bolt.

According to one embodiment, the tapered bolt of the drive mechanism can be a shear bolt.

According to one embodiment, the drive mechanism can include: a drive bolt; and a tapered rear face of the pressure member configured to engage the drive bolt.

According to one embodiment, the drive bolt of the drive mechanism according to the preceding embodiment can be a shear bolt.

According to one embodiment, the drive mechanism can include: a spring; and a retention mechanism; wherein the spring is configured and arranged to force the pressure member toward the end face of the cable conductor when the retention mechanism is operated to release the spring.

According to one embodiment, the retention mechanism can include a set screw releasably interlocked with the pressure member.

According to one embodiment, the drive mechanism can include a cam and follower mechanism.

According to one embodiment, the securing mechanism can include a shear bolt.

According to a second aspect, a method for forming a connection with an electrical cable, the electrical cable including a cable conductor having a terminal end portion, the terminal end portion having an end face, includes providing a cable connector. The cable connector includes an electrically conductive connector body, a conductor bore in the connector body, a securing mechanism, and a contact mechanism. The connector bore defines a conductor bore axis and is configured to receive the terminal end portion of the cable conductor along the conductor bore axis. The securing mechanism is operable to clamp onto the terminal end portion. The contact mechanism includes a pressure member, an electrical contact surface, and a drive mechanism. The method includes: inserting the terminal end portion into the conductor bore; clamping the securing mechanism onto the terminal end portion to secure the terminal end portion in the conductor bore; and operating the drive mechanism to drive the pressure member to force the electrical contact surface against the end face of the cable conductor.

According to one embodiment, the cable conductor can include outer conductor strands surrounded by inner conductor strands; and when the electrical contact surface engages the end face of the cable conductor, the electrical contact surface engages both the inner conductor strands and the outer conductor strands of the cable conductor to establish electrical continuity between the inner conductor strands and the connector body through the outer conductor strands.

According to one embodiment, the method can further include mounting an elastomeric sleeve around the connector and the electrical cable.

### BRIEF DESCRIPTION OF THE DRAWINGS

FIG. 1 is a perspective view of a cable connector according to some embodiments.

FIG. 2 is a cross-sectional view of the cable connector of FIG. 1 taken along the line 2-2 of FIG. 1.

FIG. 3 is a cross-sectional view of the cable connector of FIG. 1 taken along the line 3-3 of FIG. 2.

FIG. 4 is an exploded, perspective view of the cable connector of FIG. 1.

FIG. 5 is a fragmentary, perspective view of the cable connector of FIG. 1.

FIG. 6 is a fragmentary, perspective view of an exemplary concentric neutral cable.

FIG. 7 is an enlarged, fragmentary, perspective view of the concentric neutral cable of FIG. 6.

FIGS. 8-11 are views illustrating a procedure for forming a connection assembly using the cable connector of FIG. 1, wherein FIG. 11 is a cross-sectional view of the connection assembly of FIG. 10 taken along the line 11-11 of FIG. 10.

FIG. 12 is a side view of a protected connection assembly formed using the cable connector of FIG. 1.

FIG. 13 is a cross-sectional view of the protected connection assembly of FIG. 12 taken along the line 13-13 of FIG. 12.

FIG. 14 is a cross-sectional view of cable connector according to further embodiments.

FIG. 15 is a cross-sectional view of the cable connector of FIG. 14 taken along the line 15-15 of FIG. 14.

FIG. 16 is a cross-sectional view of a cable connector according to further embodiments.

FIG. 17 is a cross-sectional view of a cable connector according to further embodiments.

FIG. 18 is a fragmentary, cross-sectional view of a cable connector according to further embodiments.

FIG. 19 is a cross-sectional view of a cable connector according to further embodiments.

FIG. 20 is a cross-sectional view of a cable connector according to further embodiments taken along the line 20-20 of FIG. 21.

FIG. 21 is a cross-sectional view of the cable connector of FIG. 20.

FIG. 22 is a cross-sectional view of a cable connector according to further embodiments.

FIG. 23 is a cross-sectional view of a cable connector according to further embodiments.

FIG. 24 is a cross-sectional view of the cable connector of FIG. 23 taken along the line 24-24 of FIG. 23.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this disclosure and the relevant art and will not be interpreted in an idealized or overly formal sense unless expressly so defined herein.

As used herein, “monolithic” means an object that is a single, unitary piece formed or composed of a material without joints or seams (i.e., seamless).

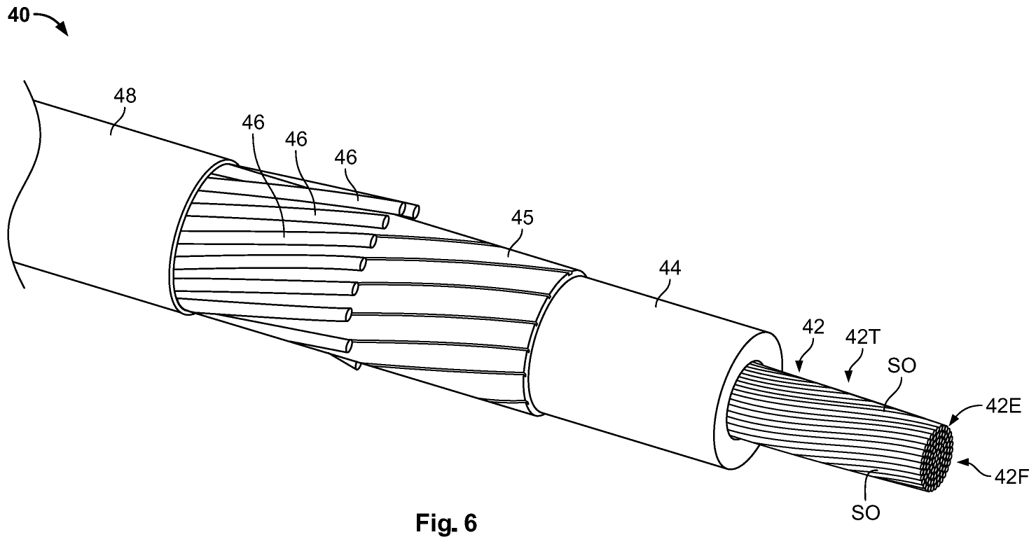

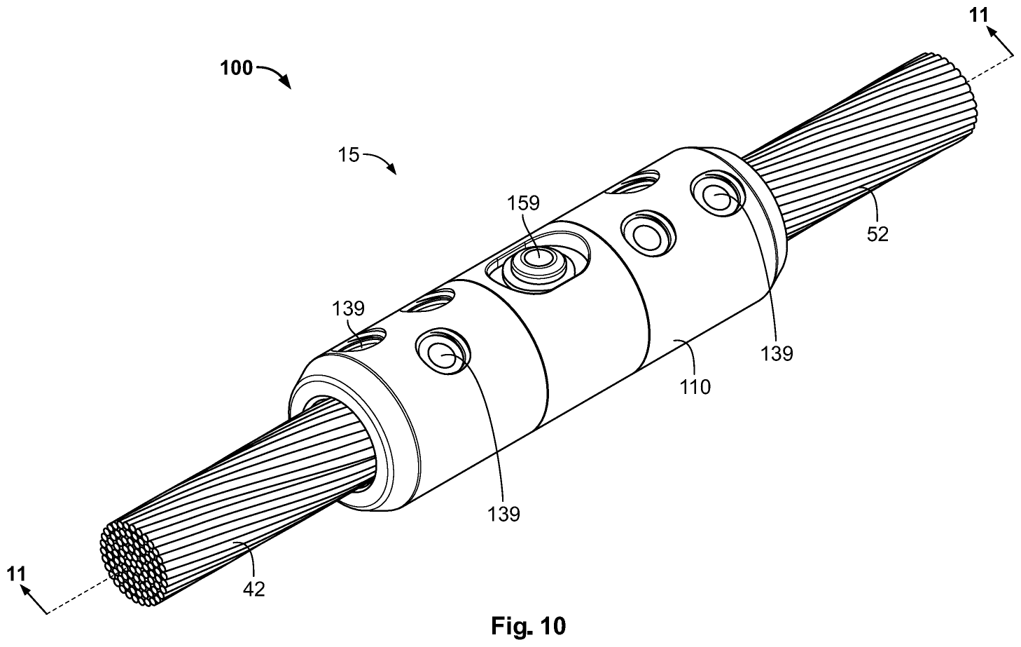

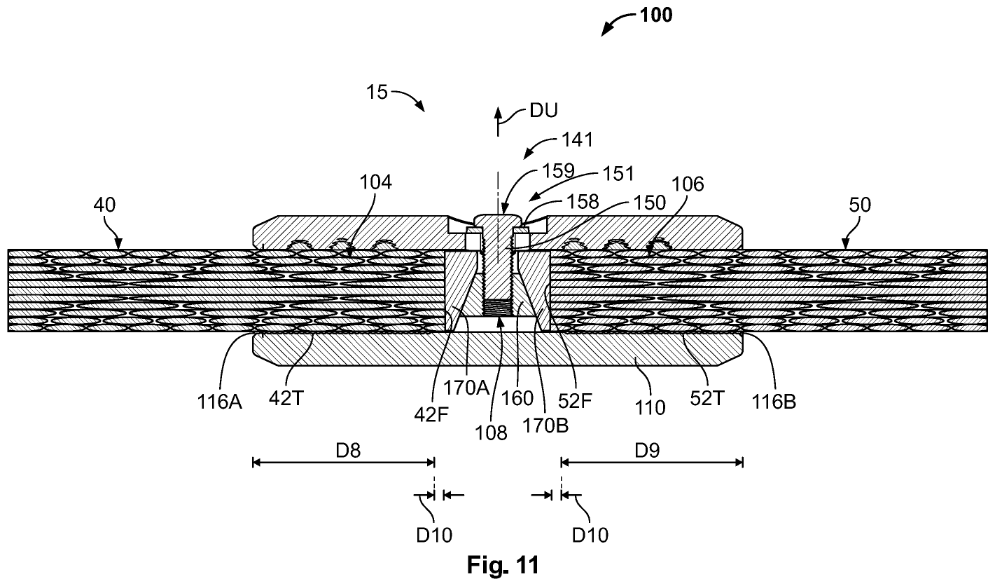

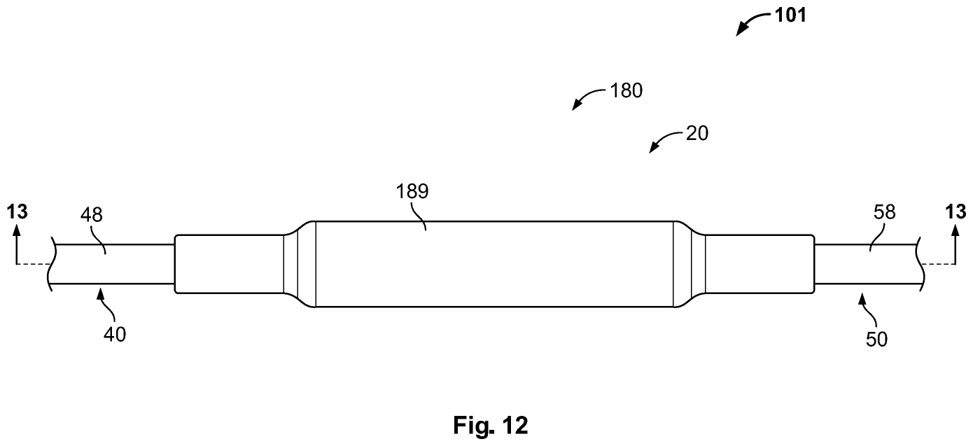

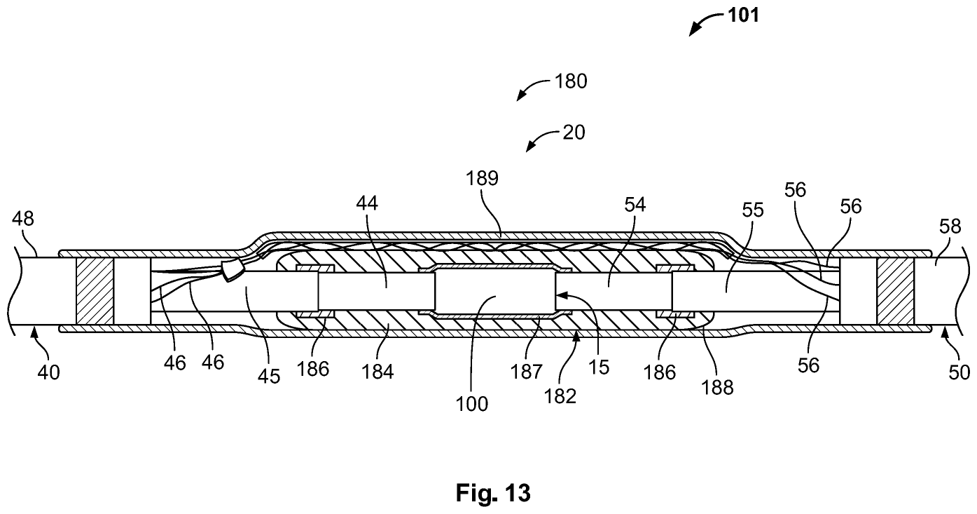

With reference to the figures, a cable connector 100 according to some embodiments of the present invention is shown therein. The connector 100 may be used to form a connection assembly 15 (FIGS. 10 and 11). The connector 100 can be used in combination with a cover system 180 to form a protected connection system 101 (FIGS. 12 and 13). The protected connection system 101 may in turn be used to form a protected connection assembly 20 including two or more connected cables (for example, cables 40, 50 as shown in FIGS. 6-8). According to some embodiments and as shown, the connector 100 is a shear bolt connector.

In some embodiments, the protected connection system 101 is provided as a pre-packaged kit of components for subsequent assembly by an installer (e.g., a field installer) using a method as described herein.

It will be appreciated that connectors (e.g., the connector 100) and methods as disclosed herein and in accordance with embodiments of the invention can be used without a cover system or with cover systems of other designs or types than the cover system 180.

It will also be appreciated that connectors (e.g., the connector 100) and methods as disclosed herein and in accordance with embodiments of the invention can be used with cables or conductors of other designs and types than the cables 40, 50.

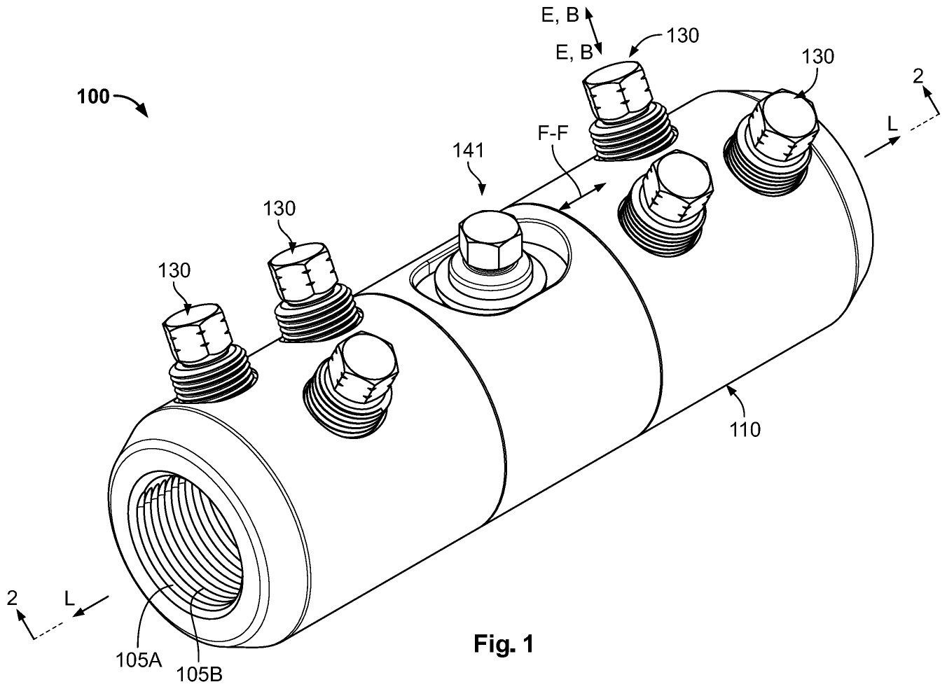

With reference to FIGS. 1-5, the connector 100 includes an electrically conductive (e.g., metal) connector body 110, a plurality of clamping bolts 130, and a contact mechanism 141. The connector 100 has a lengthwise axis L-L.

As discussed in more detail below, the contact mechanism 141 includes a drive bolt bore 140, a drive mechanism 151, and a pair of opposed interface or pressure members 170A, 170B. The drive mechanism 151 includes a drive bolt 150, a wedge member 160, and a spring 158 (e.g., a Belleville washer). The drive mechanism 151 is operable to drive the pressure members 170A, 170B against the ends of respective electrical cable conductors to provide electrical contact engagement between the cable conductors and the pressure members 170A, 170B, as discussed below.

The connector body 110 has a lengthwise axis extending substantially parallel to or concentric with the lengthwise axis L-L. The connector body 110 has opposed first and second ends 110A and 110B (referred to herein as left and right ends for the purpose of explanation).

The connector body 110 has a tubular sidewall 114. An inner surface 118 of the sidewall 114 defines opposed end openings 116A, 116B and an axially extending connector bore or barrel 102 extending along axis L-L and terminating at the end openings 116A, 116B. In some embodiments, the barrel 102 is substantially cylindrical. In some embodiments, the barrel 102 has a substantially uniform diameter from end to end.

The barrel 102 includes a first or left conductor bore 104 extending inward from the left end 110A, a second or right conductor bore 106 extending inward from the right end 110B, and a middle or central bore 108 extending between the conductor bores 104 and 106.

An outer surface 117 of the sidewall 114 is arcuate and generally cylindrical.

Clamping bolt holes or bores 120 are defined in the sidewall 114. The clamping bolt bores 120 are axially and circumferentially distributed across the body 110. Each bore 120 has a central axis E-E and extends radially through the sidewall 114 fully from the outer surface 117 to the inner surface 118. Each bore 120 includes a screw thread on its inner diameter.

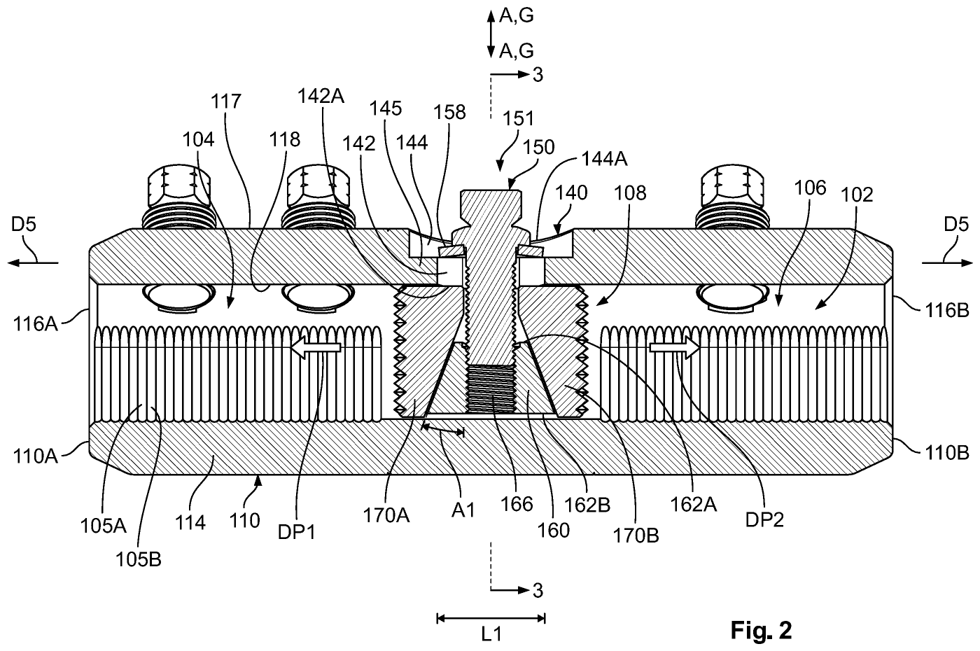

As shown in FIGS. 1 and 2, the conductor bores 104, 106 may include a series of grooves 105A and ribs 105B formed in the inner surface 118. In use, these features may improve electrical contact between the cable conductors 44, 54 and the connector body 102. In some embodiments, the grooves 105A and ribs 105B only extend circumferentially about the bores 104, 106 a limited distance and opposite the bolt bores 120. For example, in some embodiments, the grooves 105A and ribs 105B extend circumferentially about the conductor barrel axis L-L at least about 180 degrees of the circumference of the bore 104, 106 and, in some embodiments, greater than 180 degrees and less than 360 degrees.

The drive bolt bore 140 is also defined in the sidewall 114. The drive bolt bore 140 has a central axis A-A and extends radially through the sidewall 114 fully from the outer surface 117 to the inner surface 118.

The drive bolt bore 140 includes an inner opening or slot 142 and an outer section or counterbore 144. An annular flange or shoulder 145 is defined between the slot 142 and the counterbore 144.

The counterbore 144 terminates at the outer surface 117 at an opening 144A. The slot 142 terminates at the inner surface 118 at an opening 142A.

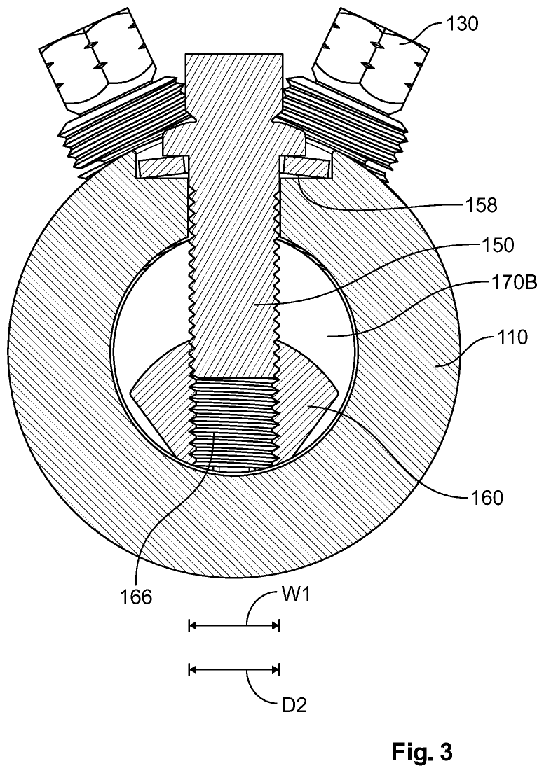

In some embodiments, the slot 142 is elongate and has a lengthwise axis F-F (FIG. 1) extending substantially parallel to the conductor barrel axis L-L. The length L1 (FIG. 2) of the slot 142 is greater than its width W1 (FIG. 3). The length L1 is greater than the diameter D2 (FIG. 3) of the portion of the drive bolt 150 therein so that the drive bolt 150 can slide along the slot 142 in opposed adjustment directions D5 (FIG. 2) along the conductor barrel axis L-L. In some embodiments, the drive bolt 150 can slide an adjustment distance in either direction D5 of at least +/−2 mm and, in some embodiments, in the range of from +/−2 mm to +/−4 mm.

The connector body 110 may be formed of any suitable material. According to some embodiments, the connector body 110 is formed of a metal. According to some embodiments, the connector body 110 is formed copper or aluminum. If the connector body 110 is formed aluminum, the surfaces of the connector body 110 in the conductor bores 104, 106 that contact the cable conductors may be tin plated.

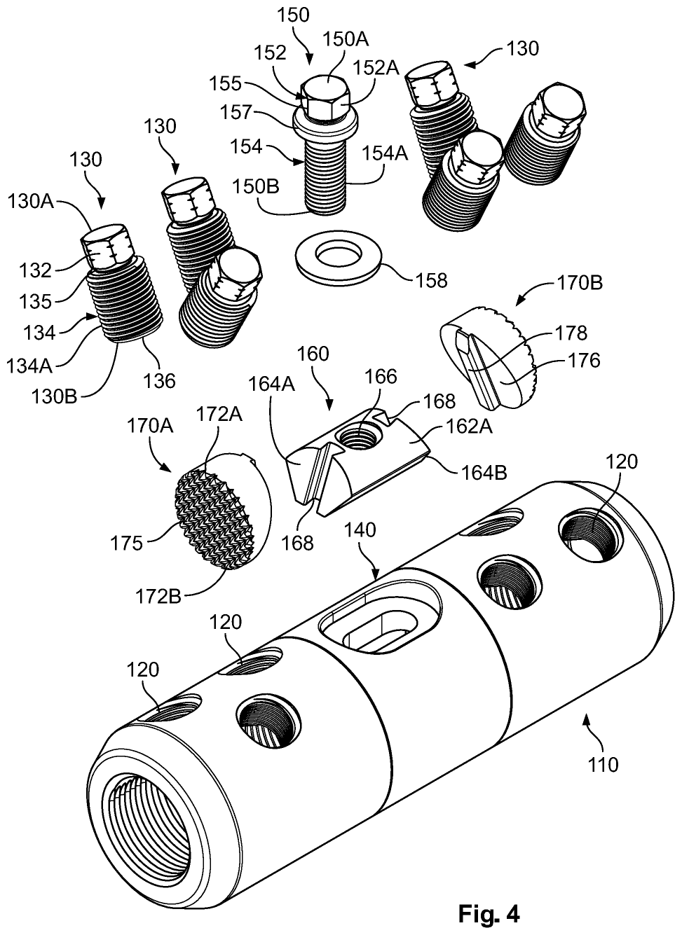

The clamping bolts 130 (FIGS. 1 and 4) serve as securing mechanisms to anchor, affix or secure the cable conductors 42, 52 to the connector body 110, and to thereby ensure mechanical and electrical connection between the conductors 42, 52 and the connector body 110. In some embodiments and as shown, the clamping bolts 130 are shear bolts. The clamping bolts 130 may each be constructed and used in the same manner. Therefore, only one of the clamping bolts 130 will be described in detail hereinbelow, it being understood that this discussion applies likewise to the other clamping bolts 130.

The clamping bolt 130 has a lengthwise axis B-B (FIG. 1), an outer or proximal end 130A, and an opposing inner or distal end 130B.

With reference to FIG. 4, the clamping bolt 130 is unitary and includes a head or drive section 132 at the proximal end 130A, a shank 134 at the distal end 130B, and a shearing or breakaway section 135 located between the drive section 132 and the distal end 130B. The shank 134 terminates an engagement surface 136.

The drive section 132 includes a driver engagement feature 132A, such as a faceted head (e.g., as shown) or socket. The driver engagement feature 132A is configured to operably engage a driver so that the clamping bolt 130 can be forcibly rotated about the axis B-B by the driver. The outer diameter of the shank 134 includes a screw thread 134A.

In use, the threaded section 134A of the shank 134 is threadedly engaged with the bore thread of a respective one of the bores 120. The shank 134 extends through the bore 120 such that the engagement surface 136 is located proximate the conductor bore 104 and the driver engagement feature 132A is accessible from outside the connector body 110. In some embodiments and as shown, the drive section 132 projects radially outwardly beyond the outer surface 117.

The clamping bolt 130 is adapted to be screwed down into its respective bolt bore 120 to clamp a conductor in the underlying conductor bore 104. The drive section 132 on the clamping bolt 130 is configured to shear off of the threaded shank 134 at the breakaway section 135 when subjected to a prescribed torque.

The clamping bolt 130 may be formed of any suitable material. According to some embodiments, the clamping bolt 130 is formed of a metal (e.g., copper or aluminum).

In some embodiments, the breakaway section 135 is located between the drive section 132 and the shank 134. In some embodiments, the clamping bolt 130 has multiple shear planes and may be referred to as multiple shear plane bolt. In this case, the clamping bolt 130 has multiple shearing or breaking sections 135. In some embodiments, some or all of the multiple shear planes or sections are located in the threaded portion of the shank 134. Likewise, in the case of a clamping bolt 130 having a single breakaway section, the breakaway section may be located in the threaded portion of the shank 134.

Shear bolts of other designs and constructions may be used in place of the clamping bolts 130. For example, each clamping bolt 130 may have a multi-part construction including a shear bolt body and a breakaway bolt or screw disposed in a bore of the shear bolt body.

The clamping bolt bores 120 and bolts 130 may be provided in any suitable number and pattern. For example, as shown in FIG. 1, the connector 100 may include three clamping bolts 130 for each bore 104, 106, and the bores 120 may direct the bolts 130 at opposing angles into the bore 104, 106.

In some embodiments and as illustrated the drive bolt 150 is a shear bolt. With reference to FIG. 4, the drive bolt 150 has a lengthwise axis G-G (FIG. 2), an outer or proximal end 150A, and an opposing inner or distal end 150B.

The drive bolt 150 is unitary and includes a head or drive section 152 at the proximal end 150A, a shank 154 at the distal end 150B, a shearing or breakaway section 155 located between the drive section 152 and the shank 154, and an annular shoulder or flange 157 between the breakaway section 155 and the drive section 152.

The drive section 152 includes a driver engagement feature 152A, such as a faceted head (e.g., as shown) or socket. The driver engagement feature 152A is configured to operably engage a driver so that the drive bolt 150 can be forcibly rotated about the axis G-G by the driver. The outer diameter of the shank 154 includes a screw thread 134A.

The shank 154 extends through the bore 140 such that shank 154 is located in the bore 108 and the driver engagement feature 152A is accessible from outside the connector body 110. In some embodiments and as shown, the drive section 152 projects radially outwardly beyond the outer surface 117. A threaded section 154A of the shank 154 is threadedly engaged with the wedge member threaded bore 166 (discussed below).

The drive section 152 on the drive bolt 150 is configured to shear off of the threaded shank 154 at the breakaway section 155 when subjected to a prescribed torque.

The drive bolt 150 may be formed of any suitable material. According to some embodiments, the drive bolt 150 is formed of a metal (e.g., copper, steel, or aluminum).

Shear bolts of other designs and constructions may be used in place of the drive bolt 150. For example, the drive bolt 150 may have a multi-part construction including a shear bolt body and a breakaway bolt or screw disposed in a bore of the shear bolt body.

In some embodiments, the spring 158 is a spring washer and, in some embodiments and as illustrated, is a Belleville washer. The Belleville washer 158 is captured between the shoulder 145 of the connector body 110 and the flange 157 of the drive bolt 150. In use, the Belleville washer 158 is elastically deflected or deformed between the shoulder 145 and the flange 157 when sufficient torque is applied to the drive bolt 150. The Belleville washer 158 may be formed of any suitable material, such as spring steel.

The wedge member 160 (FIGS. 2-5) has a leading or upper end 162A and an opposing trailing or lower end 162B. The wedge member 160 includes a threaded bore 166 and opposed sidewalls 164A, 164B. The sidewalls 164A, 164B are sloped at an oblique angle A1 relative to the axis A-A in opposed directions so that the wedge member 160 tapers down in the direction from the lower end 162B to the upper end 162A. An integral interlock or coupling feature in the form of an integral, axially extending slot or groove 168 is defined in each sidewall 164A, 164B. Each groove 168 may be V- or T-shaped in cross-section and slopes in the same manner as the sidewall 164A, 164B it is formed in.

The wedge member 160 may be formed of any suitable material. According to some embodiments, the wedge member 160 is formed of a metal. According to some embodiments, the wedge member 160 is formed copper or aluminum.

The pressure members 170A, 170B may be substantially identical. Therefore, only on the pressure member 170A will be described immediately below, it being understood that this description also applies to the pressure member 170B.

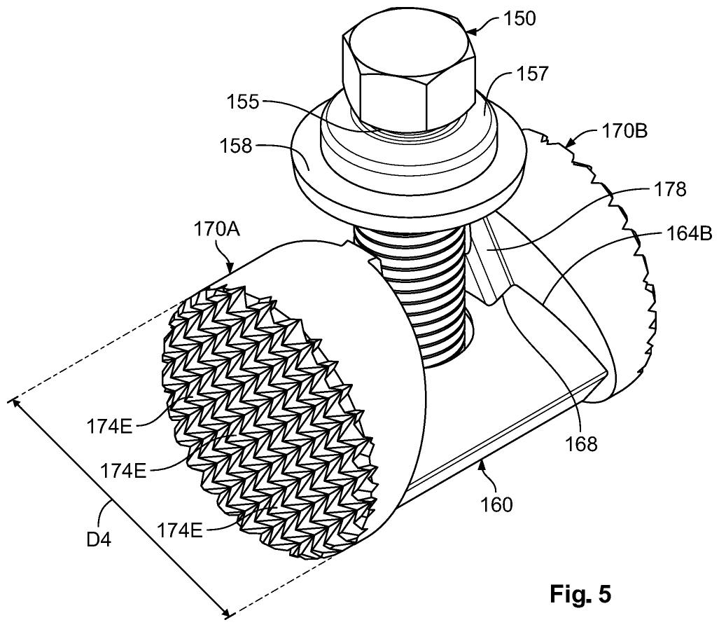

The pressure member 170A may be generally disc-shaped. The outer profile of the pressure member 170A may substantially match the inner profile of the conductor bore 104. In some embodiments, a tolerance is provided between the outer periphery of the pressure member 170A and the conductor bore 104 so that the pressure member 170A can slide through the pressure member 170A without substantial interference. In some embodiments, the outer diameter D4 (FIG. 5) of the pressure member 170A is in the range of from about 0.7 mm to 1.1 mm less than the inner diameter of the conductor bore 104.

With reference to FIG. 4, the pressure member 170A has an upper end 172A and a lower end 172B. The pressure member 170A has a front wall or face 175 and a rear wall or face 176. The front face 175 extends generally parallel to the axis A-A and generally orthogonal to the axis L-L. The front face 175 serves as an electrical contact surface, as discussed herein.

The rear face 176 is sloped relative to the axis A-A so that the pressure member 170A tapers down in the direction from the upper end 172A to the lower end 172B.

An integral interlock or coupling feature in the form of an axially extending rib or rail feature 178 projects outwardly from the rear face 176. The rail 178 may be V- or T-shaped in cross-section (e.g., generally matching the shape of corresponding groove 168) and slopes in the same manner as the rear face 176.

The front face 175 may include contact enhancement features or texturing. For example, and as shown, the front face 175 may include a pattern or array of protrusions or pyramid features 174E projecting forwardly from the front face 175.

Each pressure member 170A may be formed of any suitable material. According to some embodiments, the pressure member 170A is formed of a metal. According to some embodiments, the pressure member 170A is formed copper or aluminum. If the pressure member 170A is formed aluminum, the front face 175 (which is intended to contact a cable conductor) may be tin plated.

The connector 100 and the contact mechanism 141 may be assembled as follows. The rails 178 of the pressure members 170A, 170B are slidably seated in the grooves 168 of the wedge member 160. This subassembly is then inserted into the central bore 108 through one of the openings 116A, 116B. The drive bolt 150 is inserted through the Belleville washer 158 and the bore 140, and threaded into the threaded bore 166 of the wedge member 160. The slidable coupling or interlocks between the rails 178 and the grooves 168 secure the pressure members 170A, 170B to the wedge member 160, which is in turn secured to the connector body 110. This prevents the pressure members 170A, 170B from unintentionally sliding down the conductor bores 104, 106 or becoming mis-oriented. The clamping bolts 130 may be partially threaded into their bores 120.

The drive bolt 150, the bore 140, the wedge member 160, and the cooperating features rear faces 176 of the pressure members 170A, 170B collectively form the drive mechanism 151. Generally as described in more detail below, the drive bolt 150 can be rotationally driven to pull or translate the wedge member 160 in an upward direction DU (FIG. 11) relative to connector body 110 and the pressure members 170A, 170B. The mating ramped surfaces the wedge member 160 the pressure members 170A, 170B convert this translation to translation of the pressure member 170A in a first outward direction DP1 (FIG. 2) relative to the connector body 110 and translation of the pressure member 170B in an opposing second outward direction DP2 (FIG. 2) relative to the connector body 110. That is, the torque applied to the drive bolt 150 forces the wedge member 160 up, which in turn forces or pushes the pressure members 170A, 170B in opposed directions toward the connector openings 116A, 116B. The pressure members 170A, 170B can be loaded or displaced in this manner until the drive section 152 breaks away from a remainder 159 of the bolt 150 at the shear section 155.

The cover system 180 (FIGS. 12 and 13) includes a tubular inner sleeve or joint body 182 and a tubular outer sleeve or rejacket sleeve 189. In some embodiments, the components 182, 189 are provided on and deployed from a holdout. The components may be provided pre-expanded on a single holdout, or on respective individual holdouts. In some embodiments, the cover system 180 includes only the rejacket sleeve 189.

The joint body 182 includes a tubular insulation layer 184, a pair of axially opposed, tubular stress cone layers 186, a Faraday cage layer 187, and a tubular outer semiconductive layer 188. In some embodiments, the Faraday cage layer 187, the stress cone layers 186, and the insulation layer 184 are bonded (e.g., adhered or molded) together to form a unitary component.

The insulation layer 184 can be formed of any suitable material. According to some embodiments, the insulation layer 184 is formed of a dielectric or electrically insulative material. According to some embodiments, the insulation layer 184 is formed of an elastically expandable material. According to some embodiments, the insulation layer 184 is formed of an elastomeric material. According to some embodiments, the insulation layer 184 is formed of liquid silicone rubber (LSR). Other suitable materials may include EPDM or ethylene propylene rubber (EPR). According to some embodiments, the insulation layer 184 has a Modulus at 100 percent elongation (M100) in the range of from about 0.4 to 1.1 MPa.

The Faraday cage layer 187 is a generally tubular sleeve bonded to the inner surface of the insulation layer 184. The Faraday cage layer 187 may be formed of a suitable electrically conductive elastomer. In use, the Faraday cage layer 187 may form a Faraday cage to provide an equal potential volume about the connector 100 so that an electric field is cancelled in the surrounding air voids.

The stress cone layers 186 are generally tubular sleeves bonded to the inner surface of the insulation layer 184 at either end thereof. The stress cone layers 186 may be formed of a suitable electrically conductive elastomer. In use, the stress cone layers 186 may serve to redistribute the voltage along the surface of the cable insulation 44, 54 to reduce or prevent the degradation of the insulation 44, 54 that might otherwise occur.

The semiconductive layer 188 may be formed of any suitable semiconductor material such as carbon black with silicone.

The rejacket sleeve 189 can be formed of any suitable material. According to some embodiments, the rejacket sleeve 189 is formed of an electrically insulative material. According to some embodiments, the rejacket sleeve 189 is formed of an elastically expandable material. According to some embodiments, the rejacket sleeve 189 is formed of an elastomeric material. According to some embodiments, the rejacket sleeve 189 is formed of ethylene propylene diene monomer (EPDM) rubber. Other suitable materials may include neoprene or other rubber.

Referring now to FIGS. 6-13, the connector system 100 and the protected connection system 101 may be used in the following manner to form a protected connection assembly 20 (FIGS. 12 and 13) between a pair of electrical power transmission cables 40, 50 including the splice connection assembly 15 (FIGS. 10 and 11). According to some embodiments, the cables 40, 50 are low-voltage or medium-voltage (e.g., between about 5 and 46 kV) power transmission cables. As shown in FIG. 6, the cable 40 includes a primary electrical conductor 42, a polymeric insulation layer 44, a semiconductor layer 45, one or more neutral conductors 46, and a jacket 48, with each component being concentrically surrounded by the next. According to some embodiments and as shown, the neutral conductors 46 are individual wires, which may be helically wound about the semiconductor layer 45. The primary conductor 42 may be formed of any suitable electrically conductive materials such as copper (solid or stranded). The polymeric insulation layer 44 may be formed of any suitable electrically insulative material such as crosslinked polyethylene (XLPE) or EPR. The semiconductor layer 45 may be formed of any suitable semiconductor material such as carbon black with silicone. The neutral conductors 46 may be formed of any suitable material such as copper. The jacket 48 may be formed of any suitable material such as EPDM.

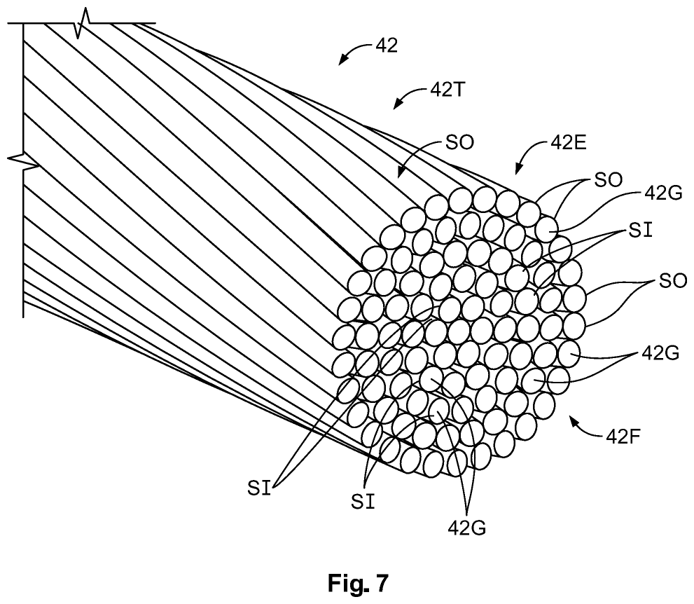

With reference to FIGS. 6 and 7, in some embodiments or applications, the conductor 42 is a stranded conductor including a plurality of axially extending conductor strands SO, SI that collectively constitute the conductor 42. The strands SO, SI are generally arranged such there are outer strands SO located on the outer periphery of the conductor 42 and inner strands SI located radially interior from the outer strands SO. Thus, it will be appreciated that the outer strands SO form an exterior surface of the conductor 42, and are interposed between the inner strands SI and the exterior of the conductor 42. The free or terminal ends 42G of the strands SO, SI collectively form a conductor end face 42F at the terminal end 42E of the conductor 42.

The cable 50 is similarly constructed with a primary electrical conductor 52, a polymeric insulation layer 54, a semiconductor layer 55, one or more neutral conductors 56, and a jacket 58 corresponding to components 42, 44, 45, 46 and 48, respectively. In some embodiments or applications, the conductor 52 is likewise a stranded conductor including a plurality of axially extending conductor strands that collectively constitute the conductor 52. The free or terminal ends of the strands SO, SI of the conductor 52 collectively form a conductor end face 52F at the terminal end 52E of the conductor 52.

It will be appreciated that the end faces 42F, 52F may be irregular. The ends of the conductor strands constituting the end face 42F, 52F may extend different distances from one another and gaps or voids may be present between strands at the end face 42F, 52F.

The connection assembly 15 may be formed and the cover system 180 may be installed as follows. The cables 40, 50 are prepared as shown in FIG. 6 such that a segment of each layer extends beyond the next overlying layer, except that one or more of the neutral conductors 46, 56 may extend beyond the ends of the respective primary conductors 42, 52.

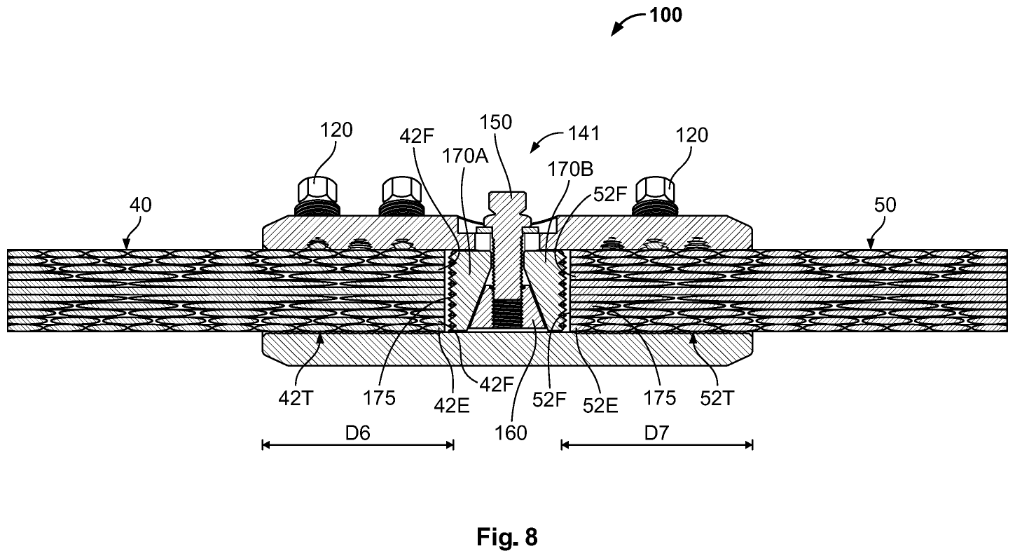

The electrical connector 100 is secured to each primary conductor 42, 52 to mechanically and electrically couple the primary conductors 42, 52 to one another. More particularly, the connector 100 is provided with the contact mechanism 141 in a ready configuration as shown in FIG. 8. In the ready configuration, the pressure members 170A, 170B are each in a pressure member first, ready or retracted position. In their retracted positions, the pressure member 170A is spaced a first distance D6 (FIG. 8) from the opening 116A it faces, and the pressure member 170B is spaced a first distance D7 from the opening 116B it faces.

The connector 100 may be supplied from the manufacturer to the installer in the ready configuration. If necessary, the installer can place the contact mechanism 141 in the ready configuration by rotating the drive bolt 150 counterclockwise to thereby drive the wedge member 160 away from the slot 142 (i.e., in a direction opposite the direction DU).

With the contact mechanism 141 in the ready configuration, an exposed terminal end portion 42T (including the exposed terminal end 42E) of the conductor 42 is inserted into the conductor bore 104 through the left opening 116A, and an exposed terminal end portion 52T (including the exposed terminal end 52E) of the conductor 52 is inserted into the conductor bore 106 through the right opening 116B along the conductor bore axis L-L. The end face 42F of the conductor 42 is placed closely adjacent or in contact with the front face 175 of the pressure member 170A. The end face 52F of the conductor 52 is placed adjacent or in contact with the front face 175 of the pressure member 170B. In some embodiments, the end faces 42F, 52F are placed in contact with the protrusions 174E of their respective pressure members 170A, 170B (e.g., in contact with the outer tips of the protrusions 174E). In FIG. 8, small gaps are shown between the ends of the conductors 42, 52 and the pressure members 170A, 170B for the purpose of discussion; however, in practice it may be desirable to install the conductors without these gaps.

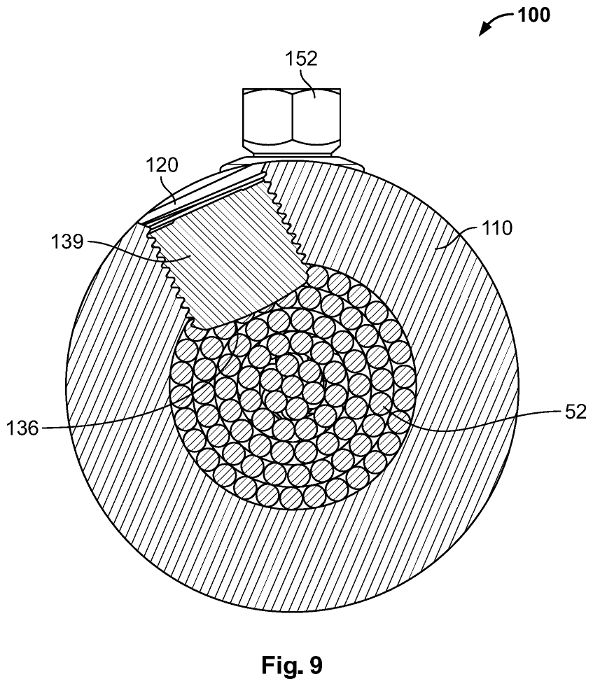

With the conductors 42, 52 and the contact mechanism 141 positioned as described, each clamping bolt 130 is screwed down through its bore 120 into contact with a conductor 42, 52. The clamping bolts 130 are further driven in (e.g., using a driver engaged with the drive feature 132A) until a prescribed torque is applied to the clamping bolt 130. At the prescribed torque, the drive section 132 of the clamping bolt 130 shears or breaks off from the shank 134 at the breakaway section 135, as shown in FIGS. 9 and 10. The conductors 42, 52 are thereby compressively loaded by the remaining portions 139 of the clamping bolts 130 and radially clamped between the engagement surfaces 136 of the clamping bolts 130 and the opposing portions of the sidewall 114. In some embodiments, the conductors 42, 52 are tightly clamped by the clamping bolts 130 so that axial displacement of the conductors 42, 52 relative to the connector body 110 during the following steps of using the contact mechanism 141 is substantially prevented.

With the conductors 42, 52 thus anchored, fixed, clamped, secured or locked in place in the connector body 110 by the bolts 130 and the contact mechanism 141 in the ready configuration, the drive bolt 150 is then rotationally driven (e.g., using a driver engaged with the drive feature 152A). As discussed above, the rotation of the bolt 150 in the threaded bore 166 of the wedge member 160 pulls or translates the wedge member 160 in the upward direction DU (FIG. 11), which pushes or forcibly translates or slides the pressure member 170A in the first outward direction DP1 relative to the connector body 110 and pushes or forcibly translates or slides the pressure member 1708 in the outward direction DP2 relative to the connector body 110. As the wedge member 160 translates in direction DU, the grooves 168 of the wedge member 160 slidably translate over the rails 178 of the pressure members 170A, 1708. The drive bolt 150 is driven until a prescribed torque is applied to the drive bolt 150. At the prescribed torque, the drive section 152 of the drive bolt 150 shears or breaks off from the shank 154 at the breakaway section 155.

More particularly, the displacement of the pressure members 170A, 1708 in the directions DP1, DP2 is ultimately prevented by the end faces 42F, 52F of the conductors 42, 52, so that the load applied by driver to the drive bolt 150 achieves the prescribed torque. In some embodiments or applications, each of the pressure members 170A, 1708 will translate in its direction DP1, DP2 some distance before being prevented by the corresponding conductor end face 42F, 52F from further translation. For example, the pressure members 170A, 1708 may initially be spaced apart from their respective end faces 42F, 52F and/or the ends of the conductors 42, 52 may deform a limited amount. However, in some embodiments, the conductors 42, 52 are clamped in the connector body 110 with the end faces 42F, 52F in intimate contact with the pressure members 170A, 1708 (in the ready configuration) to minimize such displacement. Positioning the end faces 42F, 52F in intimate contact with the pressure members 170A, 1708 before driving the drive bolt 150 can reduce the risk that the wedge member 160 will run free (unengaged) and will limit the risk that the wedge member 160 will top out (abut the upper side of the inner surface 118) before applying the desired load to the end faces 42F, 52F.

When the drive section 152 breaks away, the contact mechanism 141 is in an engaged configuration, as shown in FIGS. 10 and 11. In the engaged configuration, the pressure members 170A, 1708 are each in a pressure member second, engaging or extended position.

In some embodiments, in the engaged configuration, the pressure member 170A is spaced a second distance D8 (FIG. 11) from the opening 116A it faces, and the pressure member 1708 is spaced a second distance D9 from the opening 1168 it faces. The second distance D8 is less than the first distance D6 (FIG. 8), and the second distance D9 is less than the first distance D7. In some embodiments, the stroke or displacement distance D10 (FIG. 11) travelled by each of the pressure members 170A, 1708 from its ready position (FIG. 8) to its engaging position is less than 2 mm and, in some embodiments, is less than 1 mm. In some embodiments, the stroke or displacement distance D10 (FIG. 11) is in the range of from about 0.5 mm to 2 mm and, in some embodiments, is in the range of from about 0.5 mm to 1 mm.

The displacement distances D10 may be different from one another. In some embodiments, the pressure members 170A, 170B are driven outward substantially simultaneously by the wedge member 160.

Once the drive section 152 has broken away from the shank 154, it is removed from the connector and may be discarded. The wedge member 160 is retained in its final position by the remaining portion 159 of the drive bolt 150. The connection 15 is thereby formed.

In this manner, the front face 175 of the pressure member 170A is pressed against the end face 42F of the conductor 42, and the front face 175 of the pressure member 170B is driven, forced, loaded or pressed against the end face 52F of the conductor 52.

More particularly, the front face 175 of the pressure member 170A makes firm mechanical and electrical contact with the terminal ends 42G of the strands SO, SI that form the end face 42F. As a result, electrical continuity is established between the inner strands SI and the outer strands SO of the conductor 42 through the pressure member 170A. Also, as a result, electrical continuity is established between the inner strands SI of the conductor 42 and the connector body 110 through the pressure member 170A.

Likewise, the front face 175 of the pressure member 170B makes firm mechanical and electrical contact with the terminal ends of the strands SO, SI that form the end face 52F. As a result, electrical continuity is established between the inner strands SI and the outer strands SO of the conductor 52 through the pressure member 170B. Also, as a result, electrical continuity is established between the inner strands SI of the conductor 52 and the connector body 110 through the pressure member 170B.

The raised contact features 174E can assist in ensuring good contact between the conductor strands SO, SI and the pressure members 170A, 170B. The raised contact features 174E can intrude axially into the spaces between the strands SO, SI, thereby increasing the available surface areas for contact.

During the installation procedure, as the wedge member 160 is translating upward, the drive bolt 150 can slide along the slot axis F-F to thereby reposition the wedge member 160 and the pressure members 170A, 170B along the axis L-L in the barrel 102. This shifting capability can enable the connector 100 to automatically adjust for unequal spacings between the conductor end faces 42F, 52F and their respective pressure members 170A, 170B.

In the completed connection 15, the Belleville washer 158 is retained by the shoulder 145 and the flange 157 in an elastically deflected state so that it exerts a persistent tension load on the drive bolt 150. This helps to retain the torque setting of the drive bolt 150 within a desired specification in the event the bolt engagement is relaxed (e.g., caused by temperature fluctuation, vibration, or other phenomena).

In some embodiments and as illustrated, the outer end of each remaining portion 139 is fully radially inset from the opening 120A of its bore 120. Similarly, in some embodiments and as illustrated, the outer end of the remaining portion 159 is fully radially inset from the opening 144A of the bore 140. In this case, the remaining portions 139, 159 do not project outwardly beyond the outer profile of the connector body 110.

The electrical connection assembly or splice 15 is thereby formed.

With reference to FIGS. 12 and 13, the cover system 180 may then be installed over the splice connection 15 to form the protected connection assembly 20. The joint body 182 is installed around the connection assembly 15. The rejacket 189 is installed around the joint body 182. The components 182 and 189 may be installed in sequential steps or in a single step (e.g., from a shared holdout). In some embodiments, when installed, the joint body 182 is elastically expanded from its relaxed shape so that the joint body 182 applies a persistent radially compressive load against the connector body 110.

In some embodiments and as illustrated, the joint body 182 includes an electrical stress control layer such as a Faraday cage 187 that surrounds the connection assembly 15.

In other embodiments, the joint body 182 may be omitted and the rejacket or another protective sleeve or other covering may be applied around the connection assembly 15.

As discussed above, the connector 100 can provide electrical continuity between the inner conductor strands SI and the outer conductor strands SO of a given conductor 42, 52 through the mated pressure member 170A, 170B. This electrical continuity provides pathways for current from the inner strands SI to the connector body 110 through the surrounding outer strands SO (which are in direct electrical contact with the connector body 110).

Also, as discussed above, electrical continuity is established between the inner strands SI of the conductors 42, 52 and the connector body 110 through the pressure members 170A, 170B.

Ordinarily, electrical continuity between the inner conductor strands SI and outer conductor strands SO may be prevented or impeded by voids, cable fillers, contaminants, or other insulating material present in the conductor 42, 52 between the conductor strands. Although the outer strands SO may make good electrical contact with the inner surface 118 of the connector body 110, the inner conductor strands SI typically do not. As a result, the current distribution may be unequal between the outer strand layer and the inner strand layers, with the outside layer being loaded disproportionately compared to the inside layers. This can create electrical resistance that causes the generation of substantial and undesirable heat or overheating in the connector. By introducing the additional pathways for current from the inner conductor strands SI to the connector body 110, the contact mechanism 141 can reduce the electrical resistance across the connector, and thereby reduce or eliminate such heat generation.

In some embodiments, one of both of the cables 40, 50 are strand fill cables. In the strand fill cable, a fill material is present between the strands SO, SI of the conductor 42, 52. The fill material extends through the voids and interstices defined between the strands SO, SI along the length of the cable. The strand fill material may be selected and positioned to inhibit or eliminate moisture, and eventual droplets of water, from travelling along the conductor strands. The strand fill material may be dielectric and impede intimate contact between the conductor strands as discussed above.

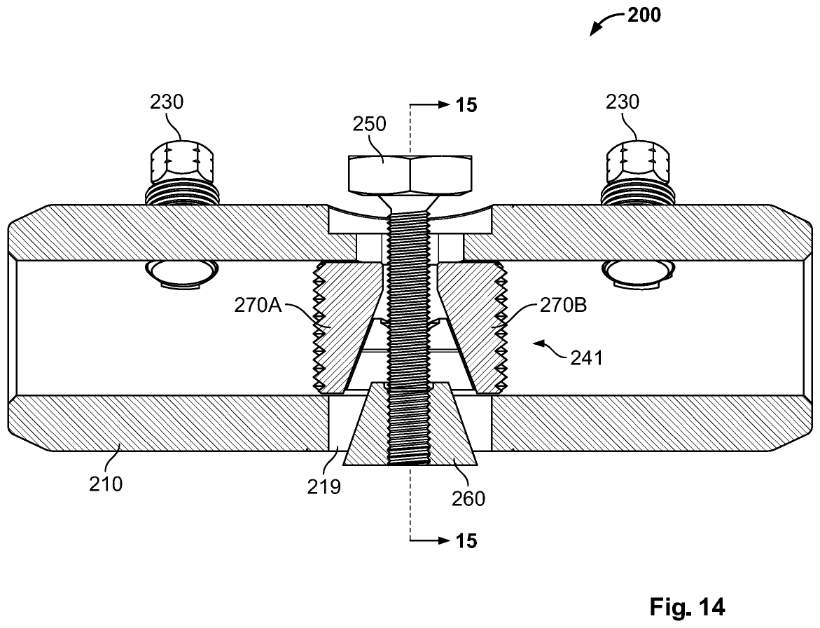

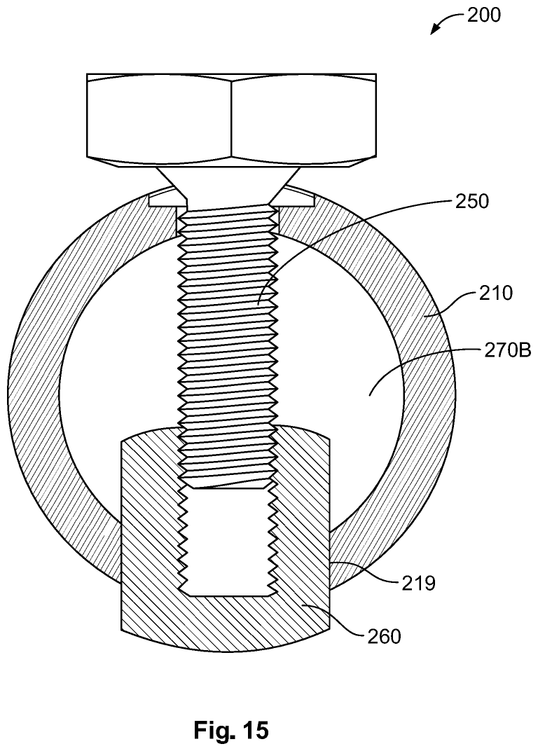

With reference to FIGS. 14 and 15, a connector 200 according to further embodiments is shown therein. The connector 200 includes a connector body 210, a contact mechanism 241, and clamping bolts 230 corresponding to the connector body 110, the contact mechanism 141, and the clamping bolts 130, respectively. The contact mechanism 240 includes pressure members 270A, 270B, a wedge member 260, and a drive bolt 250 corresponding to the components 170A, 170B, 160, and 150. The connector 200 may be constructed in the same manner as or identical to the connector 100, except as follows.

The connector body 210 of the connector 200 includes a recess, bore or opening 219. A portion of the wedge member 260 is disposed in the opening 219 when the contact mechanism 241 is in its ready position as shown in FIGS. 14 and 15.

The connector 200 can be used in the same manner as described for the connector 100. As the contact mechanism 241 is transitioned from its ready position to its engaged position, the wedge member 260 is drawn up through the opening 219. The opening 219 can thus enable a longer travel distance from the ready position to the final position for the wedge member 260. The longer travel distance can enable greater displacement distances for the pressure members 270A, 270B.

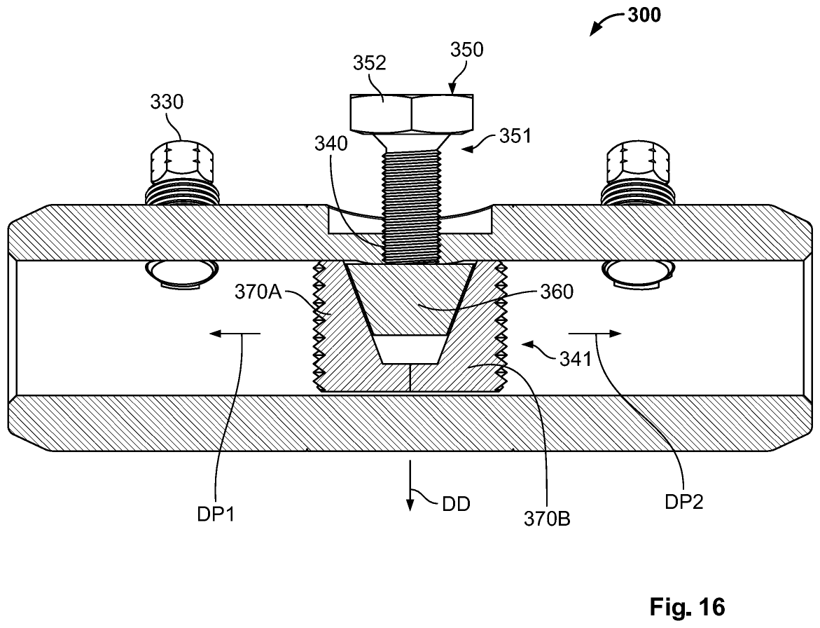

With reference to FIG. 16, a connector 300 according to further embodiments is shown therein. The connector 300 includes a connector body 310, a contact mechanism 341, and clamping bolts 330 corresponding to the connector body 110, the contact mechanism 141, and the clamping bolts 130, respectively. The contact mechanism 341 includes a drive mechanism 351 and pressure members 370A, 370B corresponding to the drive mechanism 151 and the pressure members 170A, 170B. The connector 300 may be constructed in the same manner as or identical to the connector 100, except as follows.

The drive mechanism 351 includes a drive bolt 350 in place of the drive bolt 150, a wedge member 360 in place of the wedge member 160, and a threaded opening 340 in place of the bore 140. The drive bolt 350 is threadedly engaged with the bore 340. The drive bolt 350 may be a shear bolt as described for the drive bolt 150.

In use, the drive bolt 350 is rotated in the threaded bore 340 and drives the wedge member 360 radially down (direction DD). The wedge member 360 in turn forces the pressure members 370A, 370B in axially opposed outward directions DP1, DP2 to press against the end faces of the cable conductors (not shown in FIG. 16) as described with regard to the connector 100. The drive bolt 350 may be driven until a prescribed torque is achieved and the head 352 of the drive bolt 350 shears off.

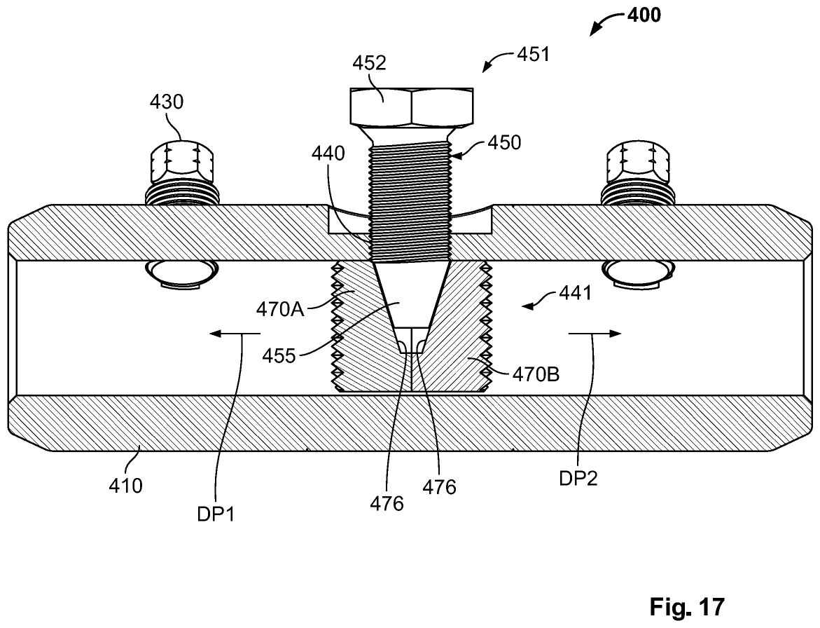

With reference to FIG. 17, a connector 400 according to further embodiments is shown therein. The connector 400 includes a connector body 410. A contact mechanism 441, and clamping bolts 430 corresponding to the connector body 110, the contact mechanism 141, and the clamping bolts 130, respectively. The contact mechanism 441 includes a drive mechanism 451 and pressure members 470A, 470B corresponding to the drive mechanism 151 and the pressure members 170A, 1708. The connector 400 may be constructed in the same manner as or identical to the connector 100, except as follows.

The drive mechanism 451 includes a drive bolt 450 in place of the drive bolt 150, and a threaded opening 440 in place of the bore 140. The drive bolt 450 is threadedly engaged with the bore 340. The drive bolt 450 may have a frustoconical leading bearing end 455. The drive bolt 450 may be a shear bolt as described for the drive bolt 150.

In use, the drive bolt 450 is rotated in the threaded bore 440 and engages the sloped rear faces 476 of the pressure members 470A, 470B. The drive bolt 450 thereby forces the pressure members 470A, 470B in axially opposed outward directions DP1, DP2 to press against the end faces of the cable conductors (not shown in FIG. 17) as described with regard to the connector 100. The drive bolt 450 may be driven until a prescribed torque is achieved and the head 452 of the drive bolt 450 shears off.

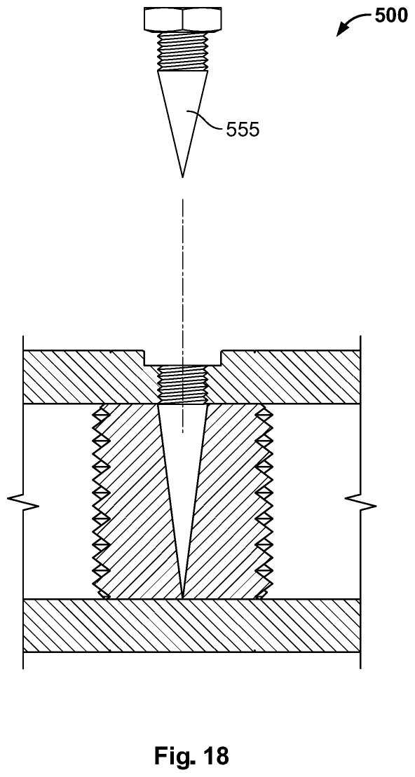

With reference to FIG. 18, a connector 500 according to further embodiments is shown therein. The connector 500 may be constructed in the same manner as or identical to the connector 400, except as follows. The drive bolt 550 of the connector 500 has a conical leading bearing end 555 in place of the frustoconical leading bearing end 455.

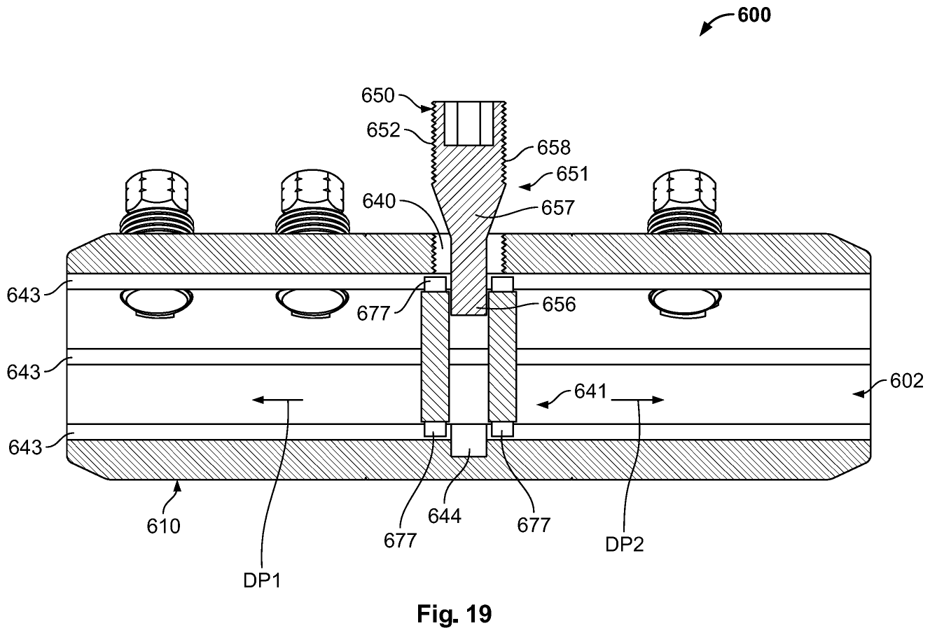

With reference to FIG. 19, a connector 600 according to further embodiments is shown therein. The connector 600 includes a contact mechanism 641 and may be constructed in the same manner as or identical to the connector 500, except as follows.

The drive bolt 650 of the contact mechanism 641 has a cylindrical, threaded leading end section 656 followed by a conical bearing section 657 and an externally threaded section 658. The drive bolt 650 may be a shear bolt. The drive bolt 650 is threadedly engaged with a threaded bore 640 in the connector body 610.

The contact mechanism 641 includes circumferentially spaced apart, axially extending guide channels 643 defined in the barrel 602 of the connector body 610. Each of the pressure members 670A, 670B includes keys features 677 that are seated in respective ones of the guide channels 643.

In use, the drive bolt 650 is rotated in the threaded bore 640 and the conical section 657 progressively engages the rear faces 176 of the pressure members 670A, 670B. The drive bolt 650 thereby forces the pressure members 670A, 670B in axially opposed outward directions DP1, DP2 to press against the end faces of the cable conductors (not shown in FIG. 19) as described with regard to the connector 100. The key features 677 and the guide channels 643 cooperate to prevent the pressure members 670A, 670B from tilting in the barrel 602. The drive bolt 650 is torqued until a prescribed torque is achieved and the head 652 of the drive bolt 650 shears off. The leading section 656 of the drive bolt 650 may thread into a threaded pocket 644 defined in the opposing wall of the connector body 610.

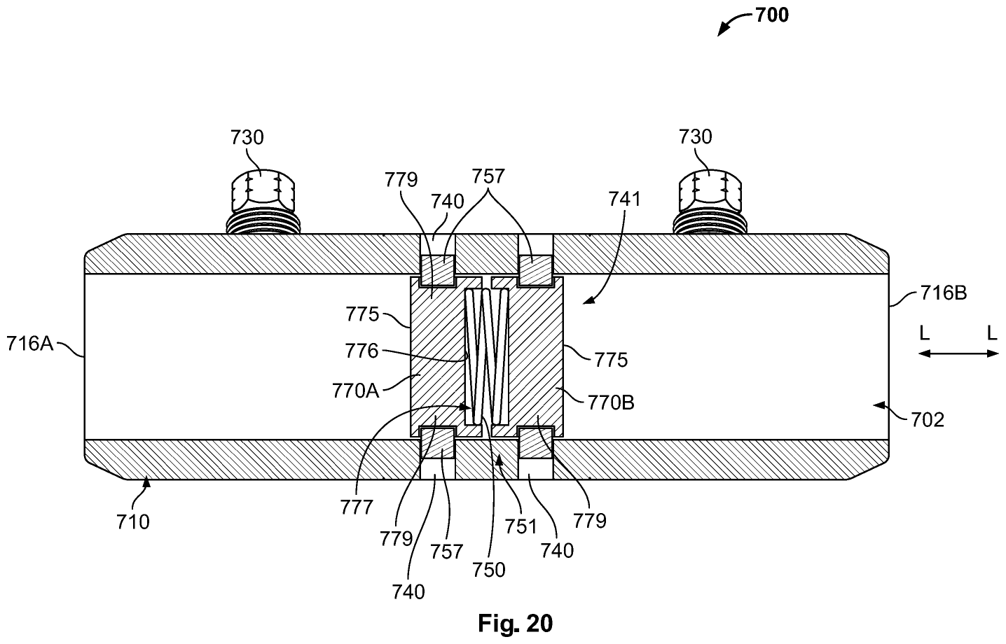

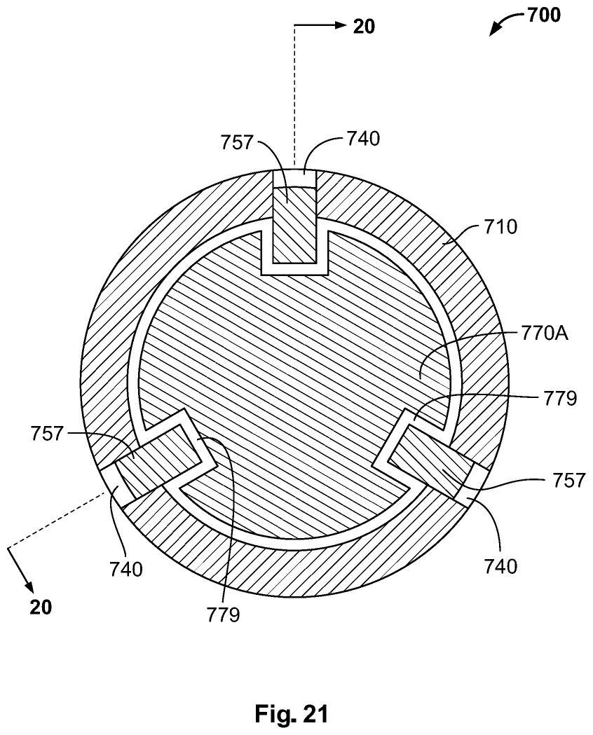

With reference to FIGS. 20 and 21, a connector 700 according to further embodiments is shown therein. The connector 700 may be constructed in the same manner as the connector 100, except as follows.

The connector 700 includes an electrically conductive (e.g., metal) connector body 710, a plurality of clamping bolts 730 (e.g., shear bolts), and a contact mechanism 741. The connector 700 has a lengthwise axis L-L.

The contact mechanism 741 includes a plurality of threaded set screw bores 740 (defined in a sidewall of the connector body 710), a drive mechanism 751, and a pair of opposed pressure members 770A, 770B. The drive mechanism 751 includes a spring 750 and a plurality (e.g., six) of set screws 757. The drive mechanism 751 is operable to drive the pressure members 170A, 1708 against and into electrical contact with the end faces 42F, 52F of respective electrical cable conductors 42, 52, as discussed below.

The connector body 710 has a lengthwise axis extending substantially parallel to or concentric with the lengthwise axis L-L. The connector body 710 has opposed first and second ends (referred to herein as left and right ends for the purpose of explanation). With the exception of the additional set screw bores 740 and the omission of a drive bolt bore 140, the connector body 710 may be constructed as described herein for the connector body 110.

The pressure members 770A, 770B may be substantially identical. Therefore, only on the pressure member 770A will be described immediately below, it being understood that this description also applies to the pressure member 770B.

The pressure member 770A has a front wall or face 775 and a rear wall or face 776. The front face 775 extends generally orthogonal to the axis L-L.

A spring retainer feature 777 (e.g., a recess) is formed on or defined in a rear face 776 of the pressure member 770A.

Set screw interlock features 779 (e.g., recesses) are formed on or defined in the peripheral side wall of the pressure member 770A.

The front face 775 may include contact enhancement features or texturing. For example and as shown, the front face 775 may include a pattern or array of protrusions or pyramid features corresponding to the features 174E (FIG. 5).

Each pressure member 770A may be formed of any suitable material. According to some embodiments, the pressure member 770A is formed of a metal. According to some embodiments, the pressure member 770A is formed copper or aluminum. If the pressure member 770A is formed aluminum, the front face 775 (which is intended to contact a cable conductor) may be tin plated.

The spring 750 is located axially between the pressure members 770A, 770B in the connector barrel 702. The spring 750 may be a spring of any suitable type and construction. In some embodiments and as illustrated, for example, the spring 750 is a coil spring.

In a ready configuration of the contact mechanism 741 as shown in (FIG. 20), the spring 750 is compressed between the pressure members 770A, 770B. The opposed ends of the spring 750 are seated in the recesses 777. The spring 750 exerts a persistent spring force on the pressure members 770A, 770B tending to force the pressure member 770A in a direction DP1 toward the connector opening 716A and the pressure member 770B in a direction DP2 toward the connector opening 716B. The pressure members 770A, 770B are prevented from moving (under the load of the spring 750) by the set screws 757, which are seated in the bores 740 and the recesses 757. The pressure members 770A, 770B are thereby retained in a first, ready or retracted position as shown in FIG. 20 by the set screws 757. In their retracted positions, the pressure member 770A is spaced a first distance from the opening 716A it faces, and the pressure member 770B is spaced a first distance from the opening 716B it faces.

In some embodiments, the connector 700 is assembled by the manufacturer and provided to the customer or installer with the contact mechanism 760 in the ready configuration.

The connector 700 may be installed as follows to mechanically and electrically couple the primary conductors 42, 52 to one another and thereby form a connection between two cables 40, 50.

The cables 40, 50 are prepared as described for the connector 100.

With the contact mechanism 741 in the ready configuration, the exposed terminal end 42E of the conductor 42 is inserted into the conductor bore 704 through the left opening 716A, and the exposed terminal end 52E of the conductor 52 is inserted into the conductor bore 706 through the right opening 716B. The end face 42F of the conductor 42 is placed closely adjacent or in contact with the front face 775 of the pressure member 770A. The end face 52F of the conductor 52 is placed adjacent or in contact with the front face 775 of the pressure member 770B.

With the conductors 42, 52 and the contact mechanism 741 positioned as described, each clamping bolt 730 is screwed down through its bore to clamp the conductor 42, 52 in its bore 704, 706 as described above for the connector 100 and the clamping bolts 130. In some embodiments, the heads of the clamping bolts 730 are broken (sheared) off as described for the clamping bolts 130.

With the conductors 42, 52 thus anchored, secured or locked in place in the connector body 110 by the bolts 130, the set screws 757 are then backed out until the inner ends of the set screws 757 are withdrawn from the interlock recesses 779. The pressure members 770A, 770B are thereby released so that the spring 750 can force the pressure members 770A, 770B in respective outward directions DP1, DP2 toward the openings 716A, 716B and the conductor end faces 42F, 52F. In some embodiments, the spring 750 forcibly translates or slides the pressure member 770A in the outward direction DP1 relative to the connector body 710 and/or forcibly translates or slides the pressure member 770B in the outward direction DP2 relative to the connector body 710.

In this manner, the front face 775 of the pressure member 770A is pressed against the end face 42F of the conductor 42, and the front face 775 of the pressure member 770B is pressed against the end face 52F of the conductor 52.

More particularly, the front face 775 of the pressure member 770A makes firm mechanical and electrical contact with the terminal ends of the strands SO, SI that form the end face 42F. As a result, electrical continuity is established between the inner strands SI and the outer strands SO of the conductor 42 through the pressure member 770A. Also, as a result, electrical continuity is established between the inner strands SI of the conductor 42 and the connector body 710 through the pressure member 770A.

Likewise, the front face 775 of the pressure member 770B makes firm mechanical and electrical contact with the terminal ends of the strands SO, SI that form the end face 52F. As a result, electrical continuity is established between the inner strands SI and the outer strands SO of the conductor 52 through the pressure member 770B. Also, as a result, electrical continuity is established between the inner strands SI of the conductor 52 and the connector body 710 through the pressure member 770B.

In the completed connection, the spring 750 is retained by the secured conductors 42, 52 in an elastically deflected state so that it exerts a persistent compression load on the pressure members 770A, 770B against the conductor end faces 42F, 52F. This helps to retain the contact pressure within a desired specification in the event the connection is relaxed (e.g., caused by temperature fluctuation, vibration, or other phenomena).

The cover system 180 (FIG. 13) may then be installed over the splice connection to form a protected connection assembly corresponding to the protected connection assembly 20.

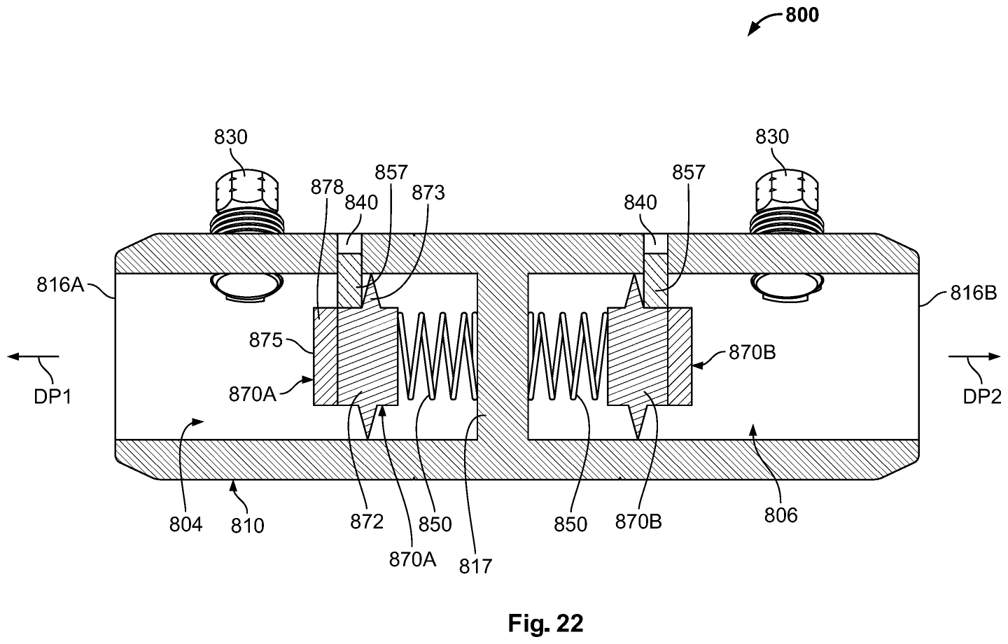

With reference to FIG. 22, a connector 800 according to further embodiments is shown therein. The connector 800 may be constructed and operated in the same manner as the connector 700, except as follows.

The connector 800 includes a connector body 810, pressure members 870A, 870B, springs 850, clamping bolts 830 (e.g., shear bolts), and set screws 857 generally constructed as described for the components 710, 770A, 770B, 750, 830, and 857, except as follows.

The connector body 810 includes an integral center wall 817. However, the center wall 817 may be omitted (and only a single spring 850 may be provided) in other embodiments.

Each pressure member 870A, 870B includes a body 872, and a radially projecting retention feature or flange 873.

Optionally, each pressure member 870A, 870B includes a contact layer 878 secured to the front face 875 of its body 872. The contact layer 878 serves as the electrical contact surface. In some embodiments, the body 872 and the contact layer 878 are formed of different materials from one another. In some embodiments, the body 872 is formed of aluminum and the contact layer 878 is formed of copper. In some embodiments, the contact layer 878 is formed of copper mesh.

In its ready position (e.g., as supplied to the customer by the manufacturer), the pressure members 870A, 870B are retained in a retracted state by the set screws 857 as shown in FIG. 22. The set screws 857 are seated in threaded bores 840. The springs 850 are compressed and exert persistent spring forces on the pressure members 870A, 870B tending to force the pressure member 870A in a direction DP1 toward the connector opening 816A and the pressure member 870B in a direction DP2 toward the connector opening 816B.

The connector 800 may be installed as follows to mechanically and electrically couple the primary conductors 42, 52 to one another and thereby form a connection between two cables 40, 50.

The cables 40, 50 are prepared as described for the connector 100. With the contact mechanism 841 in the ready configuration, the cable conductors 42, 52 are inserted into the cable bores 804, 806. The end face 42F of the conductor 42 is placed closely adjacent or in contact with the front face 875 (the contact layer 878, if present) of the pressure member 870A. The end face 52F of the conductor 52 is placed adjacent or in contact with the front face 875 of the pressure member 870B.

With the conductors 42, 52 and the contact mechanism 841 positioned as described, the clamping bolts 830 are used to affix the conductors 42, 52 in the conductor bores 804, 806 in the same manner as described for the connector 100.

With the conductors 42, 52 thus anchored, secured or locked in place in the connector body 810 by the bolts 830, the set screws 857 are then backed out until the inner ends of the set screws 857 are withdrawn from the retention features 873. The pressure members 870A, 870B are thereby released so that the springs 850 can force the pressure members 870A, 870B in respective outward directions DP1, DP2 toward the openings 816A, 816B and the conductor end faces 42F, 52F. In some embodiments, the springs 850 forcibly load, translate or slide the pressure member 870A in the outward direction DP1 relative to the connector body 810 and/or forcibly load, translate or slide the pressure member 870B in the outward direction DP2 relative to the connector body 810.

In this manner, the front face 875 of the pressure member 870A is pressed against the end face 42F of the conductor 42, and the front face 775 of the pressure member 870B is pressed against the end face 52F of the conductor 52, the same manner as described for the connector 700 and with the same effect.

In some embodiments, the set screws 857 are then screwed back into the connector body 810 to again engage the pressure members 870A, 870B and lock the pressure members 870A, 870B in place relative to the connector body 810.

The cover system 180 (FIG. 13) may then be installed over the splice connection to form a protected connection assembly corresponding to the protected connection assembly 20.

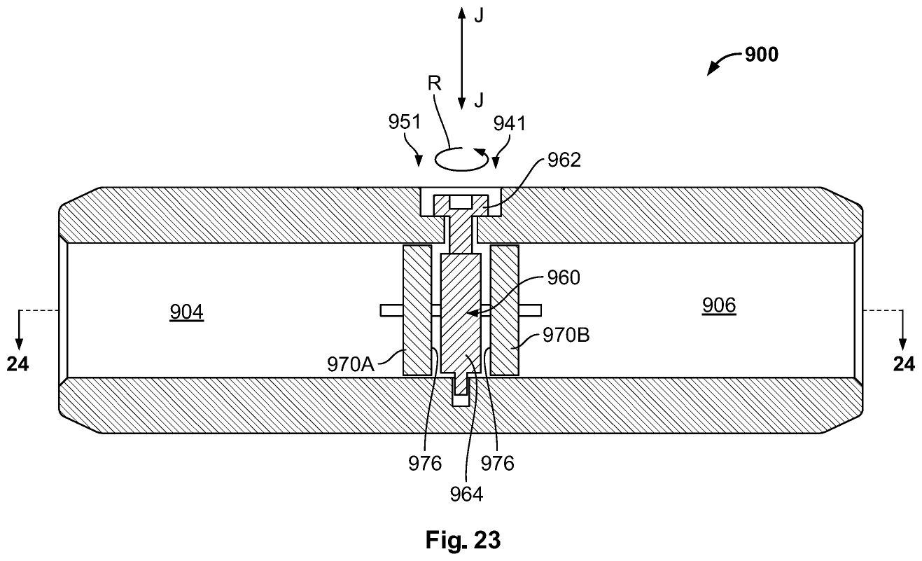

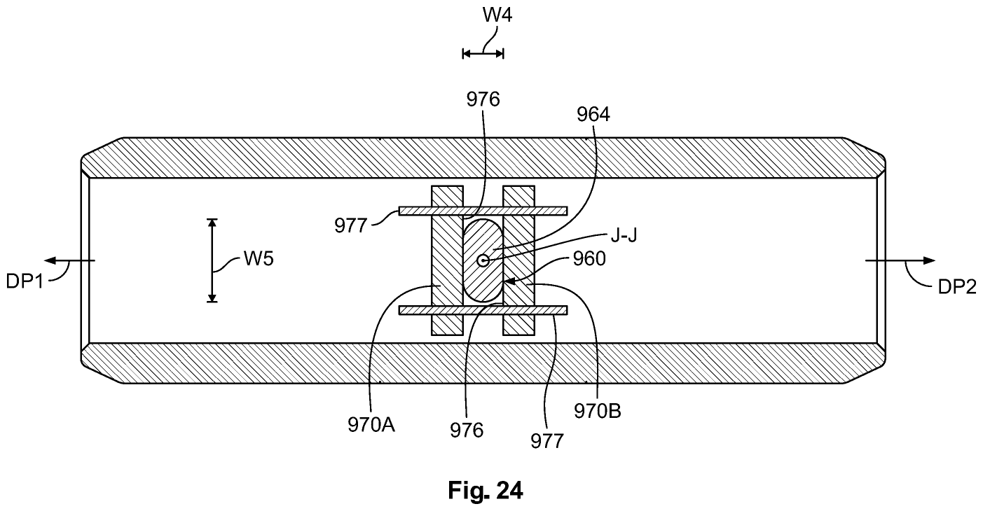

With reference to FIGS. 23 and 24, a connector 900 according to further embodiments is shown therein. The connector 900 may be constructed and operated in the same manner as the connector 100, except as follows.

The connector includes a contact mechanism 941 in place of the contact mechanism 141. The contact mechanism 941 includes pressure members 970A, 970B and a drive mechanism 951.

The pressure members 970A, 970B may be constructed and perform as described for the pressure members 170A, 1708, except that the rear faces 976 of the pressure members 970A, 970B are planar. However, it will be appreciated that other geometries may be used.

The contact mechanism 941 differs from the contact mechanism 141 in that the contact mechanism 941 includes a drive mechanism 951 in place of the drive mechanism 151. The drive mechanism 951 is a cam and follower mechanism operable to drive the pressure members 970A, 970B in outward directions DP1, DP2. The cam and follower mechanism 951 includes a cam member 960 and the rear faces 976 of the pressure members 970A, 970B (which serve as followers).

The cam member 960 includes a cam body 964 and a drive feature 962 (e.g., a drive head or socket configured to engage a drive). The cam member 960 is mounted in the connector body 910 such that it can be rotated about a rotation axis J-J using the drive feature 962. The cam body 964 is shaped such that it has a first width W4 in a first rotational orientation (about the axis J-J) and a greater second width W5 in a second rotational orientation (about the axis J-J).

The cam body 964 is positioned or interposed between the rear faces 976 of the pressure members 970A, 970B. The pressure members 970A, 970B are slidably coupled to one another by guide rails 977.

The connector 900 may be used in the same manner as the connector 100, except as follows. In the ready position of the connector 900, the cam body 964 is positioned in its first rotational orientation. After the conductors 42, 52 are secured in the conductor bores 904, 906 using the clamping bolts 930, the installer rotates or drives the cam body 964 (e.g., in direction R; FIG. 23) into its second rotational orientation using the drive feature 962. In this manner, the pressure members 970A, 970B are driven axially outward in opposed directions to press against the conductor end faces 42F, 52F.

In some embodiments, in each of the installation procedures described herein, the conductors 42, 52 are heated to an installation temperature in a prescribed range and the clamping bolts (e.g., the clamping bolts 130) are clamped onto the conductors 42, 52 are at a temperature in the prescribed installation temperature range.

Intervening electrically conductive components may be present between the pressure members and the terminal end faces 42F, 52F of the conductors 42, 52, in which case the intervening electrically conductive components may include the electrical contact surface that is selectively pressed against the terminal end faces 42F, 52F.

In some embodiments, in each of the installation procedures described herein, the procedure may include a further step of overlaying the ends 42E, 52E of the conductors 42, 52 with a copper mesh. In this case, each pressure member will engage and press against the copper mesh.

According to some embodiments, the cables 40, 50 are medium-voltage (e.g., between about 5 and 35 kV) or high-voltage (e.g., between about 46 and 230 kV) power transmission cables.

In some embodiments, the connectors as disclosed herein are configured as termination connectors instead of splice connectors. In this case, the connector may only include a single conductor bore, pressure member and electrical contact surface.

In some embodiments, the connectors as disclosed herein include other mechanisms for securing the connector to the cable conductors in place or in addition to thr clamping bolts (e.g., shear bolts 130). For example, the connector bodies may include crimpable portions that are crimped onto the cable conductive to form a mechanical and electrical connection.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A cable connector for connecting an electrical cable, the electrical cable including a cable conductor having a terminal end portion, the terminal end portion having an end face, the cable connector comprising:
an electrically conductive connector body;
a conductor bore in the connector body, the connector bore defining a conductor bore axis and being configured to receive the terminal end portion of the cable conductor along the conductor bore axis;
a securing mechanism operable to clamp onto the terminal end portion; and
a contact mechanism including:
a pressure member;
an electrical contact surface; and
a drive mechanism;
wherein the drive mechanism is selectively operable to drive the pressure member to force the electrical contact surface against the end face of the cable conductor.

2. The cable connector of claim 1 wherein the electrical contact surface forms a part of the pressure member.

3. The cable connector of claim 2 wherein the pressure member includes raised features forming the electrical contact surface.

4. The cable connector of claim 1 wherein:
the cable connector includes:
a second conductor bore in the connector body, the second connector bore being configured to receive a second terminal end portion of a second cable conductor; and
a second securing mechanism operable to clamp onto the second terminal end portion;
the contact mechanism includes:
a second pressure member; and
a second electrical contact surface; and
the drive mechanism is selectively operable to drive the second pressure member to force the second electrical contact surface against a second end face of the second cable conductor to form an electrical splice connection between the first and second cable conductors.

5. The cable connector of claim 1 wherein the electrical contact surface is configured to engage both inner conductor strands of the cable conductor and outer conductor strands of the cable conductor to establish electrical continuity between the inner conductor strands and the connector body through the outer conductor strands.

6. The cable connector of claim 1 wherein the electrical contact surface is configured to engage inner conductor strands of the cable conductor to establish electrical continuity between inner conductor strands and the connector body through the electrical contact surface.

7. The cable connector of claim 1 wherein the drive mechanism includes:
a wedge member; and
a drive bolt operable to drive the wedge member to drive the pressure member to force the electrical contact surface against the end face of the cable conductor.

8. The cable connector of claim 7 wherein:
the wedge member includes a first interlock feature;
the pressure member includes a second interlock feature; and
the first and second interlock features are engaged with one another to slidably couple the pressure member to the wedge member.

9. The cable connector of claim 7 wherein the drive bolt is a shear bolt.

10. The cable connector of claim 9 wherein the drive mechanism includes a spring operative to maintain a tension on the drive bolt.

11. The cable connector of claim 10 wherein the spring is a Belleville washer.

12. The cable connector of claim 7 wherein:
the cable connector includes:
a second conductor bore in the connector body, the second connector bore being configured to receive a second terminal end portion of a second cable conductor; and
a second securing mechanism operable to clamp onto the second terminal end portion;
the contact mechanism includes:
a second pressure member; and
a second electrical contact surface; and
the drive bolt is selectively operable to drive both:
the first pressure member to force the first electrical contact surface against the first end face of the first cable conductor, and
the second pressure member to force the second electrical contact surface against a second end face of the second cable conductor, to form an electrical splice connection between the first and second cable conductors.

13. The cable connector of claim 12 wherein:
the drive bolt is a shear bolt;
the cable connector includes an elongate slot defined in the connector body;
the drive bolt is slidably mounted in the elongate slot to permit the drive bolt to slide along the conductor bore axis;
the first electrical contact surface forms a part of the first pressure member;
the second electrical contact surface forms a part of the second pressure member; and
the first and second securing mechanisms are shear bolts.

14. The cable connector of claim 1 wherein the drive mechanism includes a tapered bolt.

15. The cable connector of claim 14 wherein the tapered bolt is a shear bolt.

16. The cable connector of claim 1 wherein the drive mechanism includes:
a drive bolt; and
a tapered rear face of the pressure member configured to engage the drive bolt.

17. The cable connector of claim 16 wherein the drive bolt is a shear bolt.

18. The cable connector of claim 1 wherein the drive mechanism includes:
a spring; and
a retention mechanism;
wherein the spring is configured and arranged to force the pressure member toward the end face of the cable conductor when the retention mechanism is operated to release the spring.

19. The cable connector of claim 18 wherein the retention mechanism includes a set screw releasably interlocked with the pressure member.

20. The cable connector of claim 1 wherein the drive mechanism includes a cam and follower mechanism.

21. The cable connector of claim 1 wherein the securing mechanism includes a shear bolt.

22. A method for forming a connection with an electrical cable, the electrical cable including a cable conductor having a terminal end portion, the terminal end portion having an end face, the method comprising:
providing a cable connector including:
an electrically conductive connector body;
a conductor bore in the connector body, the connector bore defining a conductor bore axis and being configured to receive the terminal end portion of the cable conductor along the conductor bore axis;
a securing mechanism operable to clamp onto the terminal end portion; and
a contact mechanism including:
a pressure member;
an electrical contact surface; and
a drive mechanism;
inserting the terminal end portion into the conductor bore;
clamping the securing mechanism onto the terminal end portion to secure the terminal end portion in the conductor bore; and
operating the drive mechanism to drive the pressure member to force the electrical contact surface against the end face of the cable conductor.

23. The method of claim 22 wherein:
the cable conductor includes outer conductor strands surrounded by inner conductor strands; and
when the electrical contact surface engages the end face of the cable conductor, the electrical contact surface engages both the inner conductor strands and the outer conductor strands of the cable conductor to establish electrical continuity between the inner conductor strands and the connector body through the outer conductor strands.

24. The method of claim 23 further including mounting an elastomeric sleeve around the connector and the electrical cable.
